(19) United States
(12) Patent Application Publication
(10) Pub. No.: US 2007/0005554 A1
(43) Pub. Date: Jan. 4, 2007

(54) Symbolic reference for a computer addressable data object

(75) Inventor: Denis Daviau, Toronto (CA)

Correspondence Address: OSHA LIANG L.L.P., 1221 MCKINNEY STREET, SUITE 2800, HOUSTON, TX, 77010, US

(73) Assignee: Allstream Corp., Toronto (CA)

(21) Appl. No.: 11/171,892

(22) Filed: Jun. 30, 2005

(51) Int. Cl. G06F 17/30

(52) U.S. Cl. 707/1

(57) ABSTRACT

A system, a method and a computer program product for providing a symbolic reference for a computer addressable data object. The symbolic reference can be embedded (i.e. stored) in a mark-up language script element as simple text for use in accessing the data object. The symbolic reference according to the present invention can be resolved into an address that can be used by a computer to access the data object. The data object can correspond to a markup language element defined in a computer renderable page. The markup language element can be a tagged element where the tag contains the symbolic reference. The symbolic reference comprises: an index for the markup language element, an element-type indicator and a navigable path from a known starting point to a node associated with the markup language element.

### FIELD OF INVENTION

The present invention relates to the field of computer addressable data objects. In particular, to a system, a method and a computer program product for providing a symbolic reference for a computer addressable data object.

### BACKGROUND

In an effort to provide cost effective and responsive service offerings many industries are turning to various forms of customer self-service. A common example is the availability of internet accessible applications which permit customers to select, modify or customize service offerings themselves. These applications often are internet browser (herein after browser) based. That is, the application is implemented by the service provider on an internet accessible server and the customer interacts with the server using a browser executing on a local computing platform.

A browser is a computer executable program that can request a file from a web server. The file can include a web page represented in a visual markup language such as, for example, hypertext markup language (HTML). The browser processes the visual markup language content of the web page and renders a visual representation of the content onto a computer display. The visual markup language is a text-processing language that embeds commands into text to be processed. These commands can, for example, instruct the browser to carry out formatting of the text. Tags in the form of text can be placed in the file to inform the browser of the commands to be processed and also to convey structural information (e.g. delimitation or grouping) about the text. The rendered visual representation is made up of visual nodes (i.e. elements) that correspond to tagged elements in the visual markup language content.

While sophisticated, feature-rich applications can be implemented on the combined server and browser platform, many customers impose restrictions with regard to what can be done on their local computing platforms. For example, the customer may not permit the use of browser capability extenders (a.k.a. “plug-ins”) to support advanced features in the application. Also, the service provider may limit the possible implementation strategies by choosing not to make use of solutions such as, for example, “applets” that execute in the browser due to performance considerations. The above described restrictions are problematic when the customer self-service application is particularly demanding such as, for example, in the case of a graphical editor.

For example, a telecommunications service provider offering a toll-free telephony service may wish to provide its customers with the ability to set-up, change and maintain the service logic associated with their own toll-free service subscription. A self-service application in the form of a graphical editor for editing the service logic (e.g. a routing tree) is well suited to this requirement. The browser-based graphical editor can be implemented using a browser page that contains hypertext mark-up language (HTML) and Javascript®. Javascript® is a programming language. Javascript® program units can be inserted into the HTML content of the web page and can be executed by the browser. The HTML content includes the visual representations of nodes and interconnections in the routing tree in the form of HTML text (i.e. script) elements and the Javascript® content includes executable functions and data representations for the nodes and their interconnections in the form of data objects. The nodes and their interconnections as rendered on to the browser screen can be referred to as visual elements. Complex routing trees can contain large numbers (e.g. hundreds or thousands) of nodes and interconnections with a correspondingly large number of visual elements and associated data objects. A challenge in implementing a graphical editor without the benefit of plug-ins and applets is associating individual data objects with their corresponding visual elements. Markup languages such as HTML do not, in general, support memory references (e.g. address resolvable pointers or links) to Javascript® objects. Therefore, the HTML text element associated with a visual element can not store a ‘pointer’ to its corresponding data object. This can present an implementation challenge when, for example, developing an event handler for an event associated with a visual element. In a case where the event handler needs to access the data object corresponding to the visual element it can not rely on a ‘pointer’ to the data object stored in the HTML text as none can exist. Another mechanism is required to associate the data object with its corresponding visual element.

### SUMMARY OF INVENTION

The present invention is directed to a system, a method and a computer program product for providing a symbolic reference for a computer addressable data object.

The symbolic reference can be embedded (i.e. stored) in a mark-up language script element as simple text for use in accessing the data object. The symbolic reference according to the present invention can be resolved into an address that can be used by a computer to access the data object. The data object can correspond to a markup language element defined in a computer renderable page. The markup language element can be a tagged element where the tag contains the symbolic reference. When an event associated with the tagged element is processed the symbolic reference contained in the tag can be used in addressing (i.e. locating) the data object corresponding to the tagged element. A computer navigable link (e.g. a pointer) can be derived from the symbolic reference and can be used by the event handler to access and manipulate the data object.

In accordance with one aspect of the present invention, a method for providing a symbolic reference for a computer addressable data structure to a computer executable script element having an tag field and an associated element-type, the method comprising the steps of: generating a index corresponding to the script element; creating the symbolic reference using: the index; the element-type; and a path descriptor denoting a computer navigable path from a known starting point to the data structure; and incorporating the symbolic reference into the tag field.

In accordance with another aspect of the present invention, a system for providing a symbolic reference for a computer addressable data structure to a computer executable script element having an tag field and an associated element-type, the system comprising: a index generator adapted to generating a index corresponding to the script element; a symbolic reference creator adapted to creating the symbolic reference using: the index; the element-type; and a path descriptor denoting a computer navigable path from a known starting point to the data structure; and a symbolic reference inserter adapted to incorporating the symbolic reference into the tag field.

In accordance with still another aspect of the present invention, a computer program product for providing a symbolic reference for a computer addressable data structure to a computer executable script element having an tag field and an associated element-type, the computer program product comprising: a computer usable medium having stored thereon computer-executable instructions, the computer-executable instructions when executed on a computer instructing the computer for: generating a index corresponding to the script element; creating the symbolic reference using: the index; the element-type; and a path descriptor denoting a computer navigable path from a known starting point to the data structure; and incorporating the symbolic reference into the tag field.

Other aspects and features of the present invention will become apparent to those ordinarily skilled in the art to which it pertains upon review of the following description of specific embodiments of the invention in conjunction with the accompanying figures.

### BRIEF DESCRIPTION OF DRAWINGS

The present invention will be described in conjunction with the drawings in which:

FIG. 1 is a representation of a screen display presented by a graphical editor in accordance with an exemplary embodiment of the present invention.

FIG. 2 is an illustration of exemplary tag-value pairs for a plurality of data elements that can be included in a Javascript® data object that is associated with a node as presented in the screen display of FIG. 1.

FIG. 3 is an illustration of exemplary HTML text that can be placed in a web page for processing by a browser to render the screen display of FIG. 1.

FIG. 4 is a representation of the screen display presented by the graphical editor for an iteration of the routing tree after modification relative to that of FIG. 1.

FIG. 5 is an illustration of exemplary tag-value pairs for data elements than can be included in Javascript® data objects associated with the node (Node 1) and a child node (Node 2), respectively, as presented in the screen display of FIG. 4.

FIG. 6 is an illustration of exemplary HTML text that can be placed in a web page for processing by the browser to render the screen display of FIG. 4.

FIG. 7 is a representation of the screen display presented by the graphical editor for an iteration of the routing tree after modification relative to that of FIG. 4.

FIG. 8 is an illustration of exemplary tag-value pairs for data elements than can be included in Javascript® data objects associated with node (Node 1), child node (Node 2) and second child node (Node 3), respectively, as presented in the screen display of FIG. 7.

FIGS. 9A and B are illustrations of exemplary HTML text that can be placed in a web page for processing by the browser to render the screen display of FIG. 7.

FIG. 10 is an illustration of an exemplary Javascript® function that can be invoked by an event handler associated with a mouse event such as a mouse click.

FIG. 11 is an illustration of an exemplary Javascript® function in accordance with to the present invention that can invoked by the event handler providing as input an HTML tag.

FIG. 12 is a flowchart of exemplary steps in a method according to the present invention.

FIG. 13 is a schematic representation of an exemplary embodiment of a system according to the present invention.

FIG. 14 is a schematic representation of an exemplary network of interconnected switches used to illustrate an alternative embodiment of the present invention.

### DETAILED DESCRIPTION

Described herein is a system, a method and a computer program product for providing a symbolic reference to a computer addressable data object in accordance with the present invention. The symbolic reference can be embedded (i.e. stored) in a mark-up language script element as simple text for use in accessing an associated (i.e. corresponding) data object.

The present invention will be described with reference to an exemplary browser-based graphical editor for use in a customer self-service application for editing service logic (i.e. a routing tree) for a toll-free telephony service. The routing tree can contain a plurality of nodes and interconnections (i.e. branches). In the graphical editor each of the nodes and interconnections can have a correspondingly visual element and an associated data object.

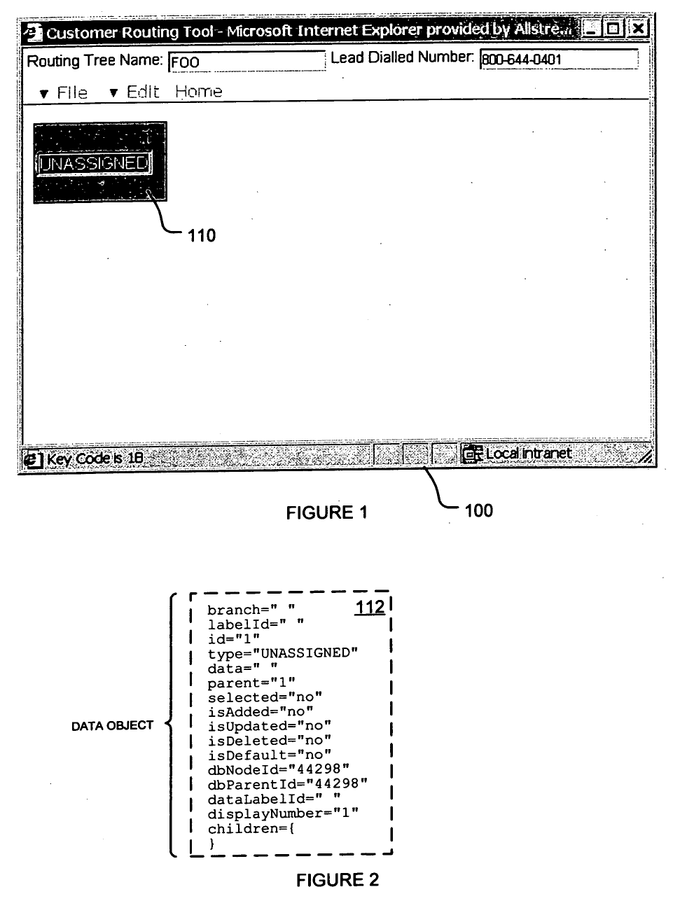

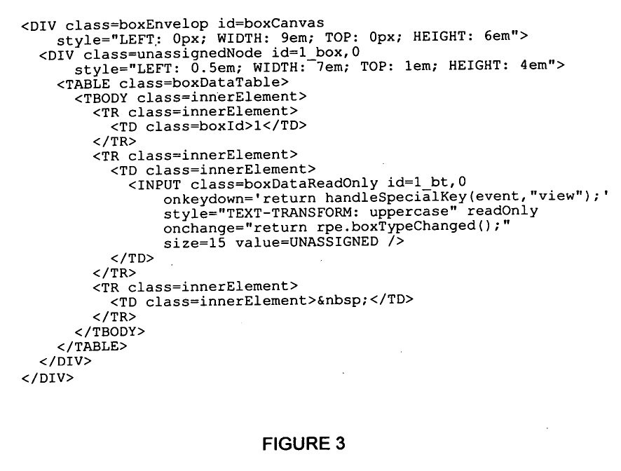

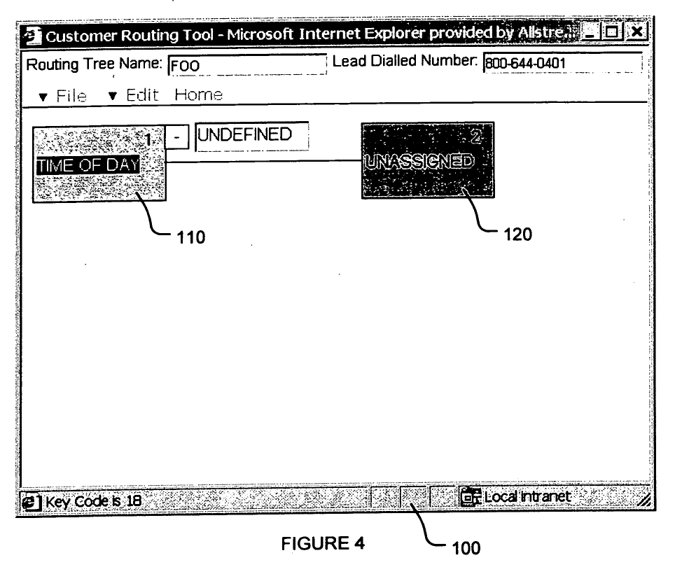

FIG. 1 is a representation of a screen display 100 presented by the graphical editor in accordance with an exemplary embodiment of the present invention. The screen display 100 is associated with a routing tree named “FOO” having a single node currently entitled “UNASSIGNED” and identified as node ‘1’ in the corresponding on-screen visual element 110. FIG. 3 illustrates exemplary HTML text that can be placed in a web page for processing by the browser to render the screen display 100 of FIG. 1. FIG. 2 illustrates exemplary tag-value pairs for a plurality of data elements that can be included in a Javascript® data object 112 that corresponds to the node (Node 1) and to the visual element 110 as presented in the screen display 100 of FIG. 1. The data object 112 can be used, for example, to provide for storing a persistent representation of the node on a web server. The persistent representation can be used, for example, to reestablishing the last state of the node when a session of the graphical editor has been terminated and subsequently a new session is initiated for further manipulation (i.e. editing) of the routing tree.

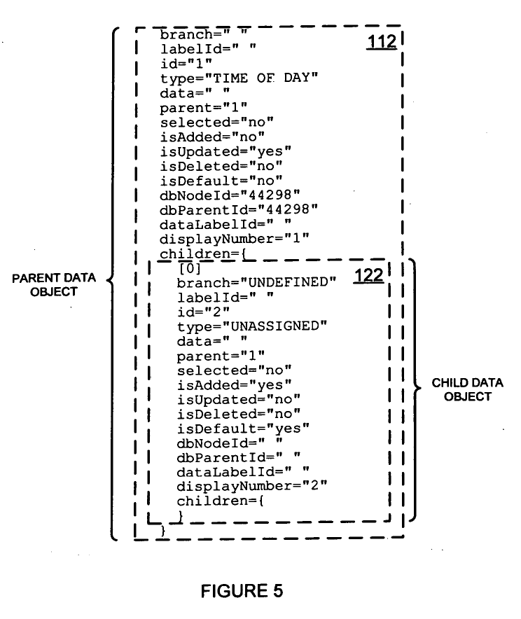

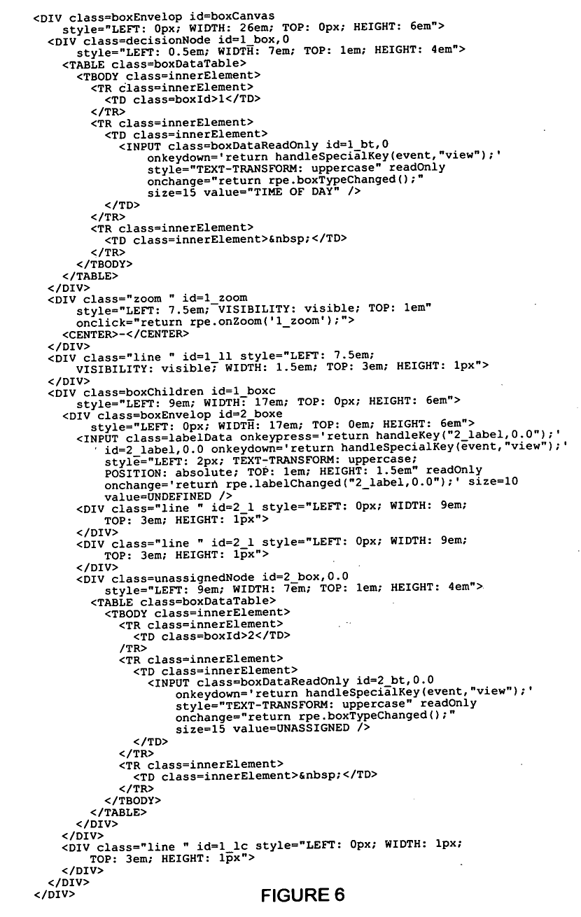

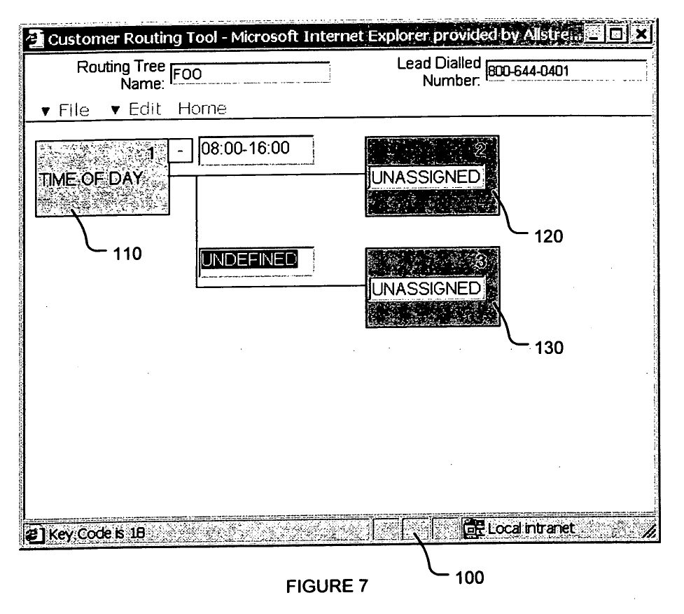

FIG. 4 is a representation of the screen display 100 presented by the graphical editor for an iteration of the routing tree “FOO” after modification relative to that of FIG. 1. In the iteration of the routing tree “FOO” of FIG. 4 the ‘type’ of the node (Node 1) has been changed to “TIME OF DATE” and the title changed accordingly. Also, a child node (Node 2) entitled “UNASSIGNED”, represented by on-screen visual element 120, has been created and linked to the parent node (Node 1) by a branch entitled “UNDEFINED.” FIG. 6 illustrates exemplary HTML text that can be placed in a web page for processing by the browser to render the screen display 100 of FIG. 4. FIG. 5 illustrates exemplary tag-value pairs for data elements than can be included in Javascript® data objects 112 and 122 associated with the parent node (Node 1) and the child node (Node 2) as represented in the screen display 100 of FIG. 4 by visual elements 110 and 120 respectively.

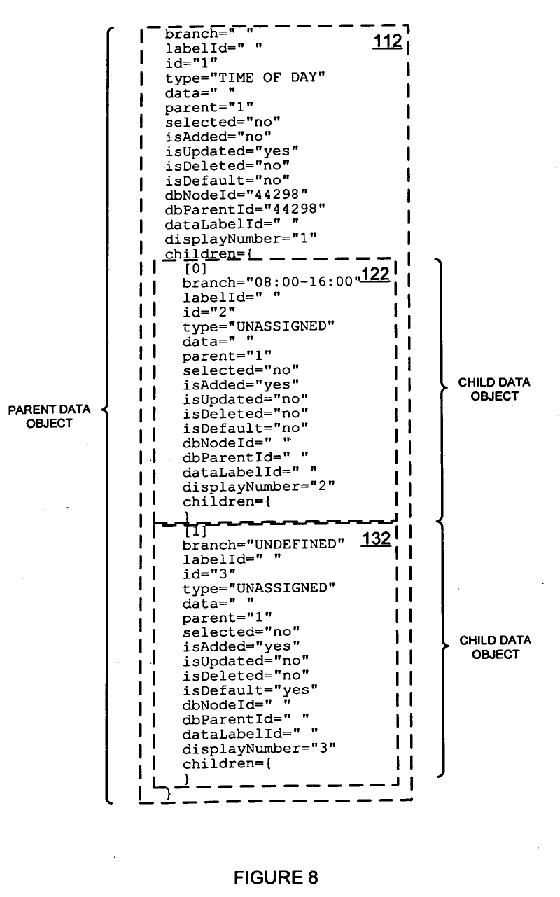

FIG. 7 is a representation of the screen display 100 presented by the graphical editor for an iteration of the routing tree “FOO” after modification relative to that of FIG. 4. In the iteration of the routing tree “FOO” of FIG. 7 the title of the branch to the child node (Node 2) has been change to “08:00-16:00” and a second child node (Node 3) entitled “UNASSIGNED”, represented by on-screen visual element 130, has been created and linked to the parent node (Node 1) by a branch entitled “UNDEFINED.”

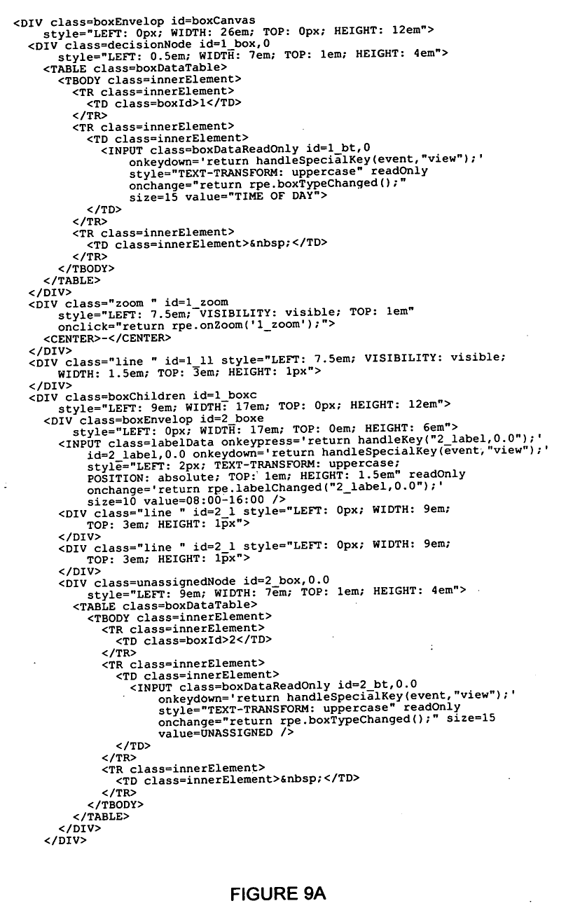

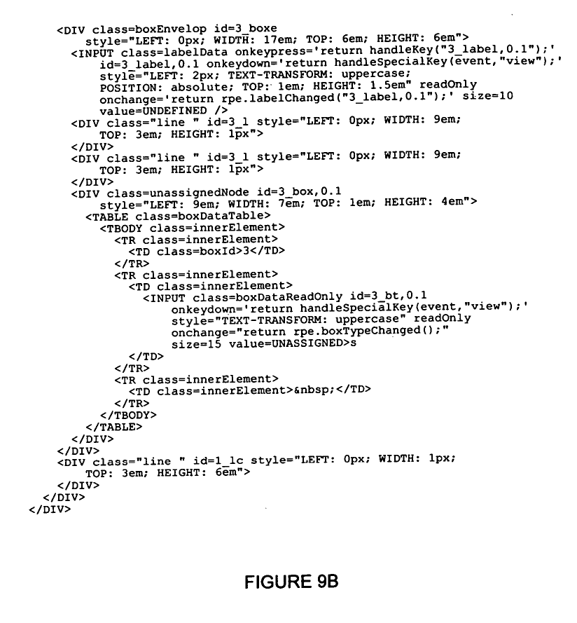

FIGS. 9A and 9B taken together illustrate exemplary HTML text that can be placed in a web page for processing by the browser to render the screen display 100 of FIG. 7. FIG. 8 illustrates exemplary tag-value pairs for data elements than can included in Javascript® data objects 112, 122 and 132 associated with parent node (Node 1), child node (Node 2) and second child node (Node 3) as represented in the screen display 100 of FIG. 7 by visual elements 110, 120 and 130 respectively.

As a user interacts with the graphical editor in order to manipulate the routing tree (eg. FOO), for example to create the iterations shown in FIGS. 1, 3 and 5, browser events can be triggered. Example events include clicking of a mouse button when an on-screen tracker is over a visual element and the simple presence of the tracker over a visual element (sometimes referred to as a roll-over event). One of these or other similar events can cause an event-handler associated with the event to be executed.

When an event occurs that is associated with a visual element, the event handler or other Javascript® implemented-code modules invoked by the event handler can require access to a data object (e.g. 112, 122 or 132) associated with the visual element and its corresponding HTML text element (e.g. nodes 110, 120, 130 respectively). The event handler is invoked by supporting infrastructure implemented in the browser.

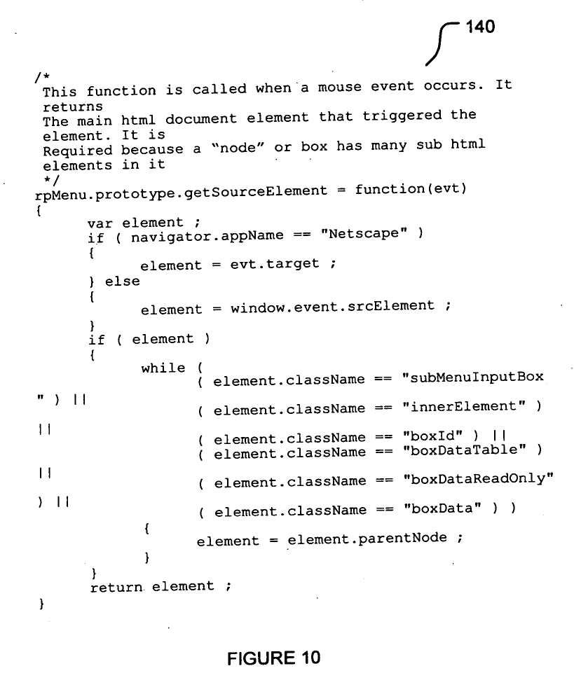

FIG. 10 illustrates an exemplary Javascript® function 140 that can be invoked by an event handler associated with a mouse event such as a mouse click. The function 140, known as ‘getSourceElement’, returns as a parameter ‘element’ that identifies the visual element (e.g. nodes 110, 120, 130) over which the mouse tracker was positioned when the event that triggered the event handler occurred. Determining the visual element associated with an event is provided for in the implementation of HTML. The function 140 also provides for the visual element associated with the event to be one of a number of sub-elements contained in a visual element (e.g. visual element 110, 120, 130) in which case the parameter ‘element’ returned will identify the containing visual element.

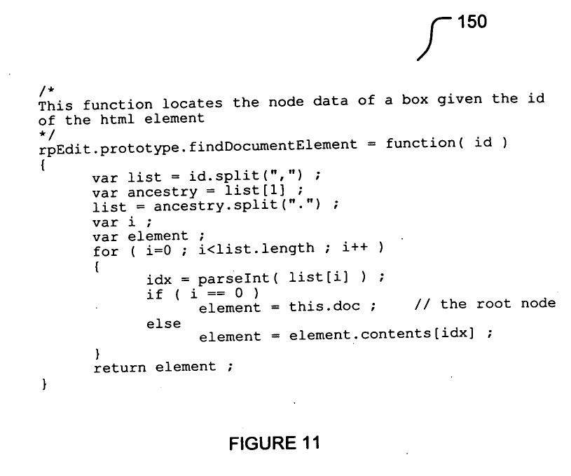

FIG. 11 illustrates an exemplary Javascript® function 150 in accordance with the present invention that can be invoked by the event handler providing as input (via input parameter ‘id’) an HTML tag for the element returned by an invocation of the function ‘getSourceElement’ as described above with reference to FIG. 10. The function 150, known as ‘findDocumentElement’, locates and returns (via return parameter ‘element’) a memory resolvable reference (e.g. a Javascript® pointer) to the data object associated with the visual element whose HTML tag was provided as input (‘id’) to the function 150.

The function 150 can locate and return a memory resolvable reference (herein after reference) to the data object derived from the HTML tag (herein after tag) that is in the form of a symbolic reference according to the present invention. The symbolic reference according to the present invention comprises three components: an index for the visual element, an element-type indicator and a navigable path from a known starting point to the node associated with the visual element. The index can, for example, be a node number associated with the visual element such as node numbers 1, 2 and 3 for visual elements 110, 120 and 130 respectively in FIG. 7. The element-type indicator can, for example, be a type of the associated node such as ‘box’ for visual elements 110, 120 and 130. The navigable path can, for example, be a symbolic path created by concatenating together hierarchal ordinal indices from a root node to the node associated with the visual element. For example, the navigable path for visual element 110 can be ‘0’ designating the associated node as the root node. The navigable path for visual element 120 can be ‘0.0’ designating the associated node as the first child of the root node (i.e. visual element 110). The navigable path for visual element 130 can be ‘0.1’ designating this as the second child of the root node (i.e. visual element 110). A navigable path according to the above described approach can be generated for any root node, progeny of the root node, sub-progeny of the progeny of the root node, sub-progeny of the sub-progeny, and so on for any numerable sub-progeny of the root node. In accordance with the above described approach the tag for the visual element 110 can be ‘1_box, 0’. The tag for the visual element 120 can be ‘2_box, 0.0’ and the tag for the visual element 130 can be ‘3_box, 0.1’.

In an alternative embodiment of the symbolic reference according to the present invention the index is preferably a unique index. The unique index provides for an implementation that favors performance considerations in particular when the number of nodes is large.

In addition to using the symbolic reference according to the present invention to locate a data object associated with a visual element, the present invention can also be used to identify a visual element associated with a data object. For a given data object the index, element-type and the navigable path according to the present invention are either known or can be easily derived and the symbolic reference for the corresponding visual element can generated. The Javascript® function “document.getElementByld” can be used to refer to the visual element associated with, for example, symbolic reference ‘3_box, 0.1’ using the following Javascript® instructions:
“var ve=document.getElementByld(‘3_box, 0.1’).

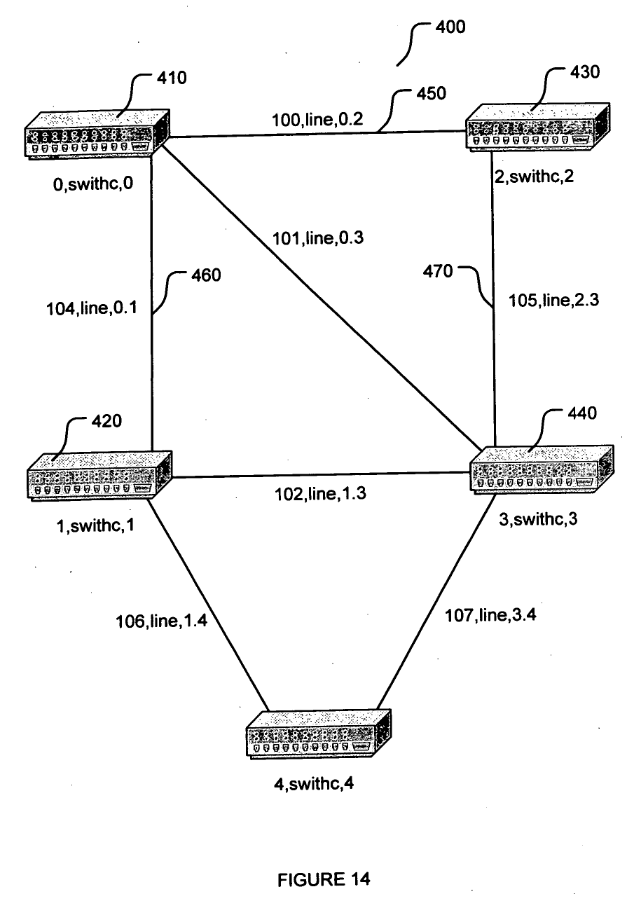

In the description above with reference to FIG. 11 and function 150 the navigable path is created by concatenating together hierarchical ordinal indices for nodes from a known starting point to a target node. The relationship between the nodes in the navigable path can be non-hierarchical while remaining within the scope and spirit of the present invention. FIG. 14 is a schematic representation of an exemplary network of interconnected switches 410, 420, 430 and 440. Switch 410, tagged ‘0,switch,0’, is connected to switch 420, tagged ‘1,switch,1’, by line 460, tagged ‘104,line,0.1’. The tag ‘104,line,0.1’ is a symbolic reference in accordance with the present invention. The navigable path component of the symbolic reference (i.e ‘0.1’) represents the connectivity relationship (‘0’ to ‘1’) of switch 410 to 420 rather than a hierarchical relationship. Similarly, the navigable path components of the symbolic reference tags of lines 450 and 470 (i.e. ‘0.2’ and ‘2.3’) represent the connectivity relationships of switch 410 to 430 (‘0’ to ‘2’) and 430 to 440 (‘2’ to ‘3’) respectively. The relationship between the known starting point to the target node in the navigable path of a symbol reference according to the present invention can be any navigable relationship while remaining within the spirit and scope of the present invention.

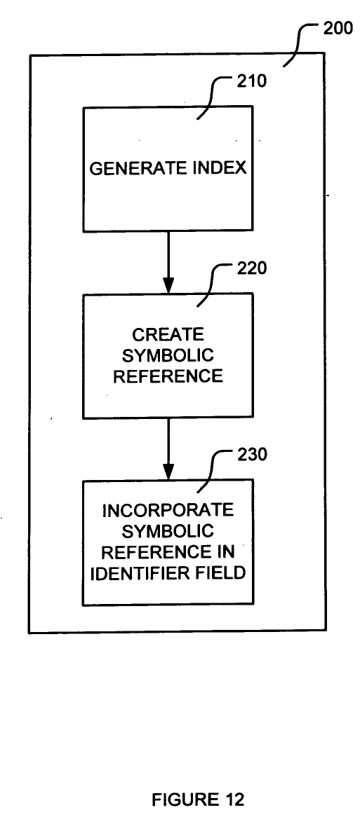

FIG. 12 is a flowchart of exemplary steps in a method 200 according to the present invention. The method 200 will be described with reference to visual element 110 and corresponding data object 112 but it will be understood that the steps of the method can apply to other visual elements and their corresponding data objects. An index is generated 210 that is associated with the visual element 110 that corresponds the data object 112. A symbolic reference is created 220 that includes three components: the index of step 210, an element-type indicator and a navigable path from a known starting point to a node associated with the visual element 110. The element-type indicator is a type associated with the visual element 110. The navigable path is a computer navigable path from a known starting point such as, for example, a root node to the node associated with the visual element 110. The path can be navigated both from the starting point to the node associated with the visual element 110 and from the node associated with the visual element to the starting point. The navigable path is mirrored in a navigable relationship amongst data objects that correspond to: the starting point, the node associated with the visual element 110 and any other intermediate nodes along the path. The navigable relationship can, for example, take the form of containment of child data objects within parent data objects. It is possible to navigate from the data object corresponding to the known starting point to the data object corresponding to visual element 110 and also to navigate in the opposite direction. The symbolic reference is incorporated 230 into a markup language tag associated with markup language text that is processed by the browser to render the visual element 110.

The method 200 according to the present invention can be implemented by a computer program product comprising a computer usable medium having stored thereon computer-executable instructions corresponding to the steps of method 200. The computer-executable instructions can be executed on any conventional computing platform (not illustrated).

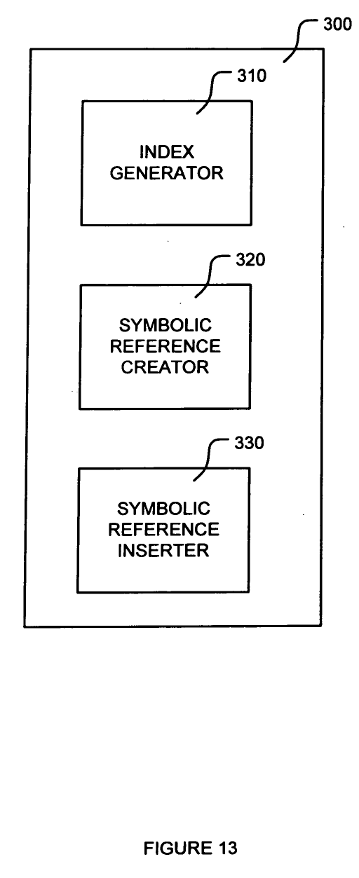

FIG. 13 is a schematic representation of an exemplary embodiment of a system 300 according to the present invention. The system 300 will be described with reference to visual element 110 and corresponding data object 112 but it will be understood that the system 300 can be applied to other visual elements and their corresponding data objects. The system 300 comprises an index generator 310, a symbolic reference generator 320 and a symbolic reference inserter 330. The index generator 310 generates an index to be associated with the visual element 110. The index can be unique within a defined space of possible indices. The indices can, for example, take the form of sequential whole numbers (e.g. 1, 2, 3, . . . etc.). The symbolic reference generator 320 generates a symbolic reference that includes three components: the index generated by the index generator 310, an element-type indicator and a navigable path from a known starting point to the node associated with the visual element 110. The element-type indicator is a type indicator associated with the visual element 110 that can, for example, take the form of a text string (e.g. ‘box’). The navigable path can, for example, be a symbolic path created by concatenating together hierarchal ordinal indices from a root node to the node associated with the visual element that is associated with the tag as described above with reference to FIG. 11. The generated symbolic reference is symbolic in that it is encoded in a manner that is independent of a specific computer language or a computer memory addressing implementation. The symbolic reference can, for example, be encoded in the form of a text string (e.g. an ASCII string). The symbolic reference inserter 330 inserts the symbolic reference into a markup language tag associated with markup language text that is processed by the browser to render the visual element 110. The symbolic reference can comprise a part or the whole of the tag.

The system 300 according to the present invention can be implemented using: logic processing devices adapted to performing the functions described above, a general purpose computing platform in combination with computer executable instructions stored in a computer usable storage medium for performing the functions described above, and combinations thereof.

The present invention has been described above with reference to an exemplary embodiment wherein the symbolic reference is placed in an HTML tag to provide a reference to a Javascript® data object. It will be understood that the symbolic reference can be placed in fields associated with a computer executable script element (e.g. other markup language scripts) and the data object can be defined in a computer programming language other than Javascript® while remaining within the spirit and scope of the present invention.

It will be apparent to one skilled in the art that numerous modifications and departures from the specific embodiments described herein may be made without departing from the spirit and scope of the present invention.

1. A method for providing a symbolic reference for a computer addressable data structure to a computer executable script element having an tag field and an associated element-type, the method comprising the steps of:
generating a index corresponding to the script element;
creating the symbolic reference using:
the index;
the element-type; and
a path descriptor denoting a computer navigable path from a known starting point to the data structure; and
incorporating the symbolic reference into the tag field.

2. The method of claim 1, wherein the index is a unique index.

3. The method of claim 1, wherein the navigable path is hierarchical.

4. The method of claim 1, wherein the data structure is a Javascript® data object.

5. The method of claim 1, wherein the tag field is a hypertext markup language (HTML) tag field.

6. A system for providing a symbolic reference for a computer addressable data structure to a computer executable script element having an tag field and an associated element-type, the system comprising:
a index generator adapted to generating a index corresponding to the script element;
a symbolic reference creator adapted to creating the symbolic reference using:
the index;
the element-type; and
a path descriptor denoting a computer navigable path from a known starting point to the data structure; and
a symbolic reference inserter adapted to incorporating the symbolic reference into the tag field.

7. The system of claim 6, wherein the index is a unique index.

8. The system of claim 6, wherein the navigable path is hierarchical.

9. The system of claim 6, wherein the data structure is a Javascript® data object.

10. The system of claim 6, wherein the tag field is a hypertext markup language (HTML) tag field.

11. A computer program product for providing a symbolic reference for a computer addressable data structure to a computer executable script element having an tag field and an associated element-type, the computer program product comprising:
a computer usable medium having stored thereon computer-executable instructions, the computer-executable instructions when executed on a computer instructing the computer for:
generating a index corresponding to the script element;
creating the symbolic reference using:
the index;
the element-type; and
a path descriptor denoting a computer navigable path from a known starting point to the data structure; and
incorporating the symbolic reference into the tag field.

12. The computer program product of claim 11, wherein the index is a unique index.

13. The computer program product of claim 11, wherein the navigable path is hierarchical.

14. The computer program product of claim 11, wherein the data structure is a Javascript® data object.

15. The computer program product of claim 11, wherein the tag field is a hypertext markup language (HTML) tag field.
